(19) United States
(12) Patent Application Publication
(10) Pub. No.: US 2025/0100874 A1
(43) Pub. Date: Mar. 27, 2025

(54) PROCESS AND PLANT FOR PRODUCING HYDROGEN FROM AMMONIA

(71) Applicants: thyssenkrupp Uhde GmbH, Dortmund (DE); thyssenkrupp AG, Essen (DE)

(72) Inventors: Alexander KLEYENSTEIBER, Wickede (Ruhr) (DE); Bernd MIELKE, Witten (DE); Klaus NOELKER, Dortmund (DE)

(73) Assignees: thyssenkrupp Uhde GmbH, Dortmund (DE); thyssenkrupp AG, Essen (DE)

(21) Appl. No.: 18/832,815

(22) PCT Filed: Jan. 27, 2023
(86) PCT No.: PCT/EP2023/052064

§ 371 Date: Jul. 24, 2024

(30) Foreign Application Priority Data
Jan. 27, 2022 (BE) BE 2022/5053
Jan. 27, 2022 (DE) 10 2022 200 903.7

(51) Int. Cl. C01B 3/04

(52) U.S. Cl. CPC C01B 3/047; C01B 2203/0277

(57) ABSTRACT

A process for producing hydrogen by cracking of ammonia includes cracking ammonia in the presence of a catalyst to hydrogen and nitrogen, wherein the ammonia is cracked without preceding noncatalytic oxidation in the absence of an oxidant merely by supply of heat in the presence of the catalyst. In one of several alternatively possible process variants, the cracking of the ammonia is conducted in a reactor analogously to a primary reformer, wherein the catalyst is disposed in at least one tube through which ammonia flows. In the combustion chamber of the reactor, a mixture of ammonia and hydrogen is preferably combusted, where the nitrogen formed in the reaction is an inert component that serves as an additional heat carrier. A mixture of hydrogen and ammonia is advantageous since it has a moderate flame temperature, has better combustion properties than pure ammonia and, depending on the mixing ratio, emits less NOx than the two pure substances.

The present invention relates to a process and to a plant for production of hydrogen by cracking of ammonia, in which ammonia is cracked in the presence of a catalyst to hydrogen and nitrogen.

The cracking of ammonia, also referred to in the jargon as “ammonia deposition” or “ammonia cracking” proceeds according to the following reaction equation: 2 NH₃→N₂+3 H₂

The reaction is endothermic and therefore requires the supply of energy to be able to proceed. The equilibrium thereof shifts to the side of the products at higher temperatures and at lower pressures.

In a CO₂-free energy economy, a problem that arises is that of spatial separation of efficient generation of renewable energies and carriers thereof and the energetic or physical utilization thereof. Hydrogen as energy carrier, by virtue of its low boiling temperature, is transportable only at high cost and inconvenience at extremely high pressures. Intermediates such as methane or ammonia can be transported much more easily and less expensively. It is therefore advisable to intermediately store renewably generated hydrogen in an intermediate such as ammonia.

But in order to be able to recover the hydrogen at the destination, it has to be released again from the intermediate. Ammonia as intermediate storage medium has the advantage of not releasing CO₂ on redissociation. The process of cracking the ammonia not only has to be able to crack ammonia catalytically to hydrogen and nitrogen and to separate both of these from one another, but also has to include an efficient form of energy integration, since heat losses are reflected very clearly in the efficiency of the process because of the low calorific value of ammonia and hydrogen.

US 2020/0123006 A1 describes a process for cracking ammonia in an autothermal ammonia cracking reactor, in which there is firstly a noncatalytic partial oxidation of the ammonia with an oxygenous gas to obtain a process gas containing nitrogen, water, fractions of nitrogen oxides and residual fractions of ammonia, followed by cracking of at least a portion of the residual fractions of the ammonia with hydrogen and nitrogen in the process gas by contact with a nickel-containing catalyst and reduction of fractions of the nitrogen oxides by reaction with hydrogen which is formed during the cracking process to give nitrogen and water. In this known process, the step of partial noncatalytic oxidation and the step of ammonia cracking can be conducted in the same reactor. The oxygenous gas used here for the partial oxidation of the ammonia in the first step may be air.

An adiabatic reaction regime with internal energy supply, as in a secondary or autothermal reformer with an external combustion chamber, entails preheating of the feed and subsequent combustion of portions of the feed to generate the energy needed for the reaction. Since the possible preheating temperature is limited by material properties and hence, given the low yield of hydrogen purification, it is simultaneously not possible to incorporate a large amount of energy from the combustion of the tail gas and a considerable amount of ammonia has to be combusted to produce the heat of reaction, a fully autothermal solution achieves only low yields of hydrogen. In one use example with a yield of the hydrogen purification of 86%, for example, the waste heat from the flue gas combustion cannot be fully utilized, and so it leaves the process at a temperature of 660° C. On the other hand, it is necessary to combust so much ammonia in the process stream that the overall molar yield of the process is only 72%.

Further disadvantages of the process known from US 2020/0123006 A1 are that water in the process gas results in poor energy recovery. Since ammonia is dissolved in the condensate, recovery is difficult. Moreover, nitrogen oxides (NOx) are formed, which have to be removed.

CN 113896168 A discloses a process for producing hydrogen or reducing gas by two-stage ammonia cracking. According to claim 1, the ammonia raw material in liquid form is first fully gasified and heated by means of a heat-exchanging gasification system and then enters the first stage of the heat-exchanging ammonia cracking reaction. The ammonia cracking reaction takes place to some extent in the first-stage system, and the heat source required for the ammonia cracking reaction is provided by heat exchange of the high-temperature ammonia cracking reaction gas of the second stage. The reaction gas that exits from the heat-exchanging ammonia cracking reaction system of the first stage enters the high-temperature ammonia cracking reaction system of the second stage, and the remainder of the ammonia cracking reaction is executed. The heat source required for the high-temperature ammonia cracking reaction of the second stage can be provided by external electrical heating, external heating by combustion of ammonia or other fuels, and by self-heating via oxygen combustion. The heat-exchanging ammonia cracking reaction system and the heat-exchanging gasification system recover the heat step-by-step from the reduced gas. If the reduced gas is to be pursued further to produce hydrogen, the reaction gas is recovered and cooled down to room temperature and then enters the PSA hydrogen extraction system in order to produce hydrogen. The process according to CN 113896168 A affords hydrogen as its product.

WO 2021/257944 A1 describes a process for producing hydrogen from ammonia, comprising:
pressurization of liquid ammonia; heating (and optionally evaporating) of the liquid ammonia by heat exchange with one or more hot fluids in order to produce heated ammonia; combustion of a fuel in a furnace in order to heat catalyst-containing reactor tubes and form a flue gas; feeding of the heated ammonia to the catalyst-containing reactor tubes to bring about cracking of the ammonia to a cracking gas containing hydrogen gas and nitrogen gas; purifying the cracking gas in a PSA device to produce a hydrogen product gas and a PSA tail gas; and separating off the PSA tail gas or a gas derived therefrom using a membrane separator in order to remove a nitrogen-rich retentate gas and to produce a hydrogen-rich permeate gas for further processing in the PSA and/or for mixing into the hydrogen product gas, where the fuel comprises one or more of ammonia, the PSA offgas, hydrogen and methane; and where the one or more hot fluids comprise the flue gas and/or the cracking gas.

Proceeding from the above-specified prior art, the problem addressed by the present invention is that of providing a process for producing hydrogen by cracking of ammonia having the features specified at the outset, in which a higher yield and a better energy balance are achievable.

The solution to the aforementioned problem is given by a process for producing hydrogen from ammonia having the features of claim 1.

According to the invention, the ammonia is cracked without preceding noncatalytic oxidation in the absence of an oxidizing agent merely by supply of heat in the presence of the catalyst. By contrast with the process known from US 2020/123006 A1, an external energy supply is thus provided in accordance with the invention.

The ammonia cracking by the process of the invention preferably comprises a five-stage operation having the following steps:
ammonia evaporation
ammonia cracking
heat recovery
ammonia recovery
hydrogen purification.

Ammonia evaporation is necessary since the ammonia is generally in the form of a liquid reactant at atmospheric pressure and a temperature below its boiling temperature of −33.5° C. Ammonia evaporation requires considerable amounts of energy. For every MW of energy input, it is possible to preheat and evaporate about 2.4 t/h of ammonia, at a pressure of 30 bar.

Ammonia cracking is the actual reaction, which also precedes thermally, but is accelerated by the use of a catalyst. The reaction can be conducted under various conditions and with various interconnections with different types of reactor, the skillful combination of which was at the focus of the developments that led to the present invention. In the context of the present application, various advantageous variants are indicated for such interconnections in plants for ammonia cracking.

Heat recovery is an essential aspect since the reaction takes place at elevated temperature. In all the preferred concepts that are presented in the present application, a burner system is used in order to thermally utilize offgases from product purification, such that hot flue gas is available as energy source and, in parallel, the hot process gas. Another internal energy carrier used is preferably process steam, such that the heat recovery is capable of fulfilling the following functions:
preheating the feed gas stream
steam generation
combustion air preheating
boiler feed water preheating.

Since it would be disadvantageous to drive a turbine with process steam for energy-related reasons, there is no need to superheat the process steam. There are various possible combinations available in the context of the present invention for the arrangement of the plant components for heat recovery.

The ammonia recovery serves to separate ammonia unconverted in the reaction from the process gas and to provide it for further utilization as combustion gas or feed gas. Ammonia can be separated out industrially in various ways, including membrane separation, adsorption and condensation, although these processes require high pressures and are therefore energy-intensive. The absorption of ammonia in water can be conducted at feasible pressures for engineering purposes, but entails expenditure of steam in order to be able to separate the mixture of ammonia and water by rectification. Since ammonia has to be combusted to generate the steam, this leads to a reduction in the hydrogen yield of the process. With skillful conduct of the reaction, it may also be possible to dispense with recovery of ammonia. This is possible in that the reaction parameters are chosen so as to maximize conversion and hence minimize the amount of ammonia remaining. This is not possible solely via a high reaction temperature since the equilibrium temperature would then have to be 900° C. or higher. But small amounts of ammonia can also be separated out concomitantly in a pressure swing adsorption, for example, which means that the recovery of the ammonia and the purification of hydrogen can be combined to one step.

The manner of hydrogen purification is dependent on the technical utilization of the product, which in turn determines the demands on quality. Technical grade hydrogen can remain relatively impure and have a purity, for example, of about 99.7%. If, by contrast, the hydrogen should be intended for use in fuel cells, much higher purities in the region of about 99.96%, for example, would be necessary. The hydrogen may, for example, be purified analogously to air fractionation by partial condensation. However, this requires the use of a compressor in order to generate the high inlet pressures required, for example of about 230 bar. Moreover, an upstream adsorptive drying unit is then necessary in order to remove traces of ammonia and water and, moreover, the separation unit itself is required. Since this concept is very costly in terms of capital costs and operation, alternatives are preferable. Membranes can only poorly separate hydrogen and nitrogen from one another; here too, a high inlet pressure must be created. Adsorptive separation in a pressure swing adsorption is therefore preferred in the context of the present invention, since it proceeds at moderate pressures and also achieves the high purities of up to more than 99.9%, with a hydrogen yield of 85%. Moreover, pressure swing adsorption (PSA) can also trap residual amounts of ammonia and water as well in the same step.

In a first possible preferred variant of the invention, the cracking of the ammonia is performed in a reactor analogous to a primary reformer, where the catalyst is disposed in at least one tube through which ammonia flows.

In a reactor of the invention which is of analogous design to a primary reformer, the catalyst may be disposed, for example, in one or more tubes through which ammonia flows from the top downward, for example. In the combustion chamber of the reactor, a mixture of ammonia and hydrogen is preferably combusted, where the nitrogen formed in the reaction is an inert component that serves as an additional heat carrier. A mixture of hydrogen and ammonia is advantageous since it has a moderate flame temperature and better combustion properties than pure ammonia and, depending on the mixing ratio, the it emits less NOx than the two pure substances. The energy generated by the combustion process in the combustion chamber of the reactor is utilized for heating of the tube or tubes through which the ammonia gas to be cracked is passed.

Useful catalysts for the catalytic cracking of the ammonia in the context of the present invention include various materials. For example, it is possible to use nickel or a nickel-containing catalyst. The temperature at which the reaction proceeds is defined in particular by the choice of catalyst system. With a nickel catalyst, for example, relatively high temperatures are required, for example in the range from about 650° C. to about 900° C. But these high temperatures ensure a high conversion of, for example, up to more than 98% percent, especially about 98.5%, and a low residual ammonia content in the product gas. The use of a nickel catalyst is advantageous in spite of the higher operating temperature and the associated more complex energy integration. The high conversion means that no dedicated separation of the ammonia is required; instead, it can be combined with hydrogen purification in one process step, for example in the form of a pressure swing adsorption.

Alternatively, for example, ruthenium or a ruthenium-containing catalyst is usable as an active component at temperatures of, for example, about 450° C. to about 500° C., although somewhat lower conversions of about 95%, for example, are achievable here. With ruthenium as active component, the reaction can therefore take place even at lower temperatures.

Alternatively, it is optionally also possible to use other catalysts at even lower temperatures. In principle, the lower the reaction temperature, the lower the conversion, and the more ammonia has to be separated out of the product gas and recycled. Ammonia can be selectively separated out in particular by adsorptive or absorptive means, and an advantageous mode of separation is one with water as absorbent in view of the considerable amounts. The recovery of the ammonia from the scrubbing water requires considerable amounts of steam to achieve the high rates of evaporation for a high degree of separation. The generation of steam in turn entails the combustion of additional ammonia and is therefore disadvantageous with regard to the hydrogen yield of the process.

The reaction temperature determines the equilibrium conversion. At 900° C. and a pressure of 20 bar, for example, the reaction proceeds nearly quantitatively. At 650° C., the ammonia conversion is about 98.5%, and at 500° C. only about 95%. A lower reaction temperature enabled by more active catalysts is therefore not always advantageous since more complex steps for separation of the remaining ammonia have to be implemented in the case of low conversions.

In principle, the optimal operating point with regard to energy economy and ammonia conversion is in particular roughly in the region of operating temperatures of about 630° C. to 640° C.

The reaction pressure is defined in particular by the design of the hydrogen purification. The stoichiometry of the reaction increases the specific volume of the gas stream; therefore, an elevated pressure has an adverse effect on conversion. On the other hand, it is advisable to operate an industrial process at higher pressures in order to limit vessel volume and hence capital costs. At a pressure of 1 bar, the reaction reaches more than 99% conversion at temperatures over and above 400° C. But since 1 bar is viable only for very small plants, plants on a standard industrial scale should be operated at higher pressures even when a certain loss of conversion has to be accepted. Ultimately, the reaction pressure is also defined by the design of the hydrogen purification. In the case of a pressure swing adsorption (PSA) as a common mode of separation for ammonia and hydrogen, which can be operated effectively, for example, within a range from about 15 bar to about 25 bar, the ammonia should preferably be handed over at the “battery limit”, for instance, with a pressure of 30 bar a. With a reactor exit pressure of, for example, about 20 bar, it is possible to satisfy the demands of the PSA, and also to limit the adverse effect of pressure on conversion.

According to the invention, the ammonia cracking reaction can in principle proceed in different types of reactor. In adiabatic processes, the internal energy of the reaction gas is used as energy source for the reaction. Examples of these are the autothermal reformer mentioned at the outset, and the secondary reformer, which work with internal energy generation. Air is added to the process gas, and a portion of the feed stream is combusted in order to increase the temperature of the gas such that the temperature is as desired at the reactor exit. A disadvantage of this process is the presence of the water formed in the combustion in the process gas, which has to be removed by condensation. This condensation dissolves a portion of the unreacted ammonia, which is lost to the process. Moreover, the high temperatures lead to a considerable amount of nitrogen oxides in the process gas, which have to be removed by inline methods.

In the inventive process regimes with external energy generation, the two aforementioned disadvantages are avoided in that the fuel gas and offgas and the process gas are physically separated from one another.

In isothermal reaction regimes, the temperature of the gas remains largely unchanged. They therefore require permanent supply of energy, for instance by the firing of a primary reformer, or electrical heating.

Mixed forms of the aforementioned variants of the process regime are possible. A fired primary reformer with an upstream fixed bed reactor combines an adiabatic reaction step and isothermal reaction step, for example. Purely adiabatic systems also need not be supplied by internal generation of energy. A reactor tray or cascade runs the feed gas in an alternating series of heating steps, each followed by reaction steps, in order to utilize the externally supplied energy as energy source.

In a preferred development of the process of the invention, the ammonia feed gas is preheated before being introduced into the reactor or into a catalyst bed and enters the reactor or the catalyst bed at a temperature of at least about 600° C. and up to about 850° C., preferably of at least about 630° C. and up to about 820° C. With optimized energy integration, the feed gas stream enters the reactor at a temperature in the order of magnitude of about 780° C. to 820° C., preferably at about 800° C.; with a reactor designed analogously to a primary reformer and in which nickel is used as catalyst, the reaction temperature in the tube(s) of the reactor that accommodate(s) the catalyst and through which the ammonia feed gas is directed is about 630° C. to about 670° C., preferably about 650° C., where the exit pressure from the reactor is preferably in the order of magnitude of about 15 bar to about 25 bar, preferably about 20 bar.

In one advantageous possible alternative variant of the process of the invention, the ammonia feed gas, before being introduced into the reactor, is first preheated for a first time and then fed to a prereformer upstream of the reactor, in which intermediate cooling occurs, and then the ammonia feed gas is heated up again to the temperature envisaged for entry into the reactor, which is, for example, within a range from about 620° C. to about 680° C., preferably in the order of magnitude of about 650° C. Thereafter, the ammonia feed gas is introduced into the reactor for the continuation of the cracking reaction. In this alternative variant, the inlet temperature into the reactor is thus lower than in the aforementioned variant, which has the advantage that there is only a lower degree of nitration of the pipelines. Two heating operations are implemented here on the ammonia feed gas, preferably with an intermediate prereformer. In this variant, the preheating of the ammonia feed gas stream is limited, for example to a temperature in the abovementioned range, which increases the lifetime of the steel in contact with the ammonia as well. The incoming ammonia gas stream is first preheated to an intended temperature, then the cracking reaction is performed to some degree in the prereformer, and then the partly cracked feed gas is preheated once again to the intended temperature and directed into the primary reformer, where the remainder of the reaction takes place.

The energy integration has to bring the ammonia feed gas to the inlet temperature of the reactor, for which it is advantageous to preheat and to evaporate demineralized water and boiler feed water and additionally to preheat the combustion air. Since the process heat exists in two strands, the process gas on the one hand and offgas from the reactor (reformer) on the other hand, the heat exchangers may be arranged in different variants in accordance with the invention. At an inlet temperature of the feed gas stream in the order of magnitude of about 650° C., for example, it is possible, for example, for a steam generator to be disposed downstream of the reactor outlet in order to avoid hydrogen embrittlement. There may also advantageously be a gas-gas heat exchanger positioned preferably downstream of the aforementioned steam generator. Since the temperature of the process gas stream is already comparatively low after the cooling that has already occurred in the gas-gas heat exchanger, it is advantageous for there to be a preheater for demineralized water which is used in the steam generation plant to be disposed downstream of the aforementioned steam generator in the flow pathway and more preferably also downstream of the aforementioned gas-gas heat exchanger.

For example, it is also possible to use an evaporator coil in the exhaust gas duct/flue gas duct of the reactor that contributes at least some of the energy for the steam generation. This increases the output of the gas-gas heat exchanger and reduces the output of the steam generator mentioned. Since all that happens here is that energy transfer is shifted from one heat exchanger to the other, there is no change in the exit temperatures in the process gas, steam and in the ammonia feed gas stream in the case of such an arrangement. In the case of low reactor exit temperatures, for example in the order of magnitude of about 500° C., the enthalpy stream of the process gas is much lower, and it is therefore advantageous to conduct the steam generation mainly or completely with flue gas from the reactor as energy source. This interconnection variant of the components for heat recovery does have the disadvantage of a smaller temperature gradient between flue gas and boller feed water in the evaporator coil, but this can be compensated for by a much larger evaporator coil or a reduction in the pressure level.

In a preferred development of the process of the invention, the ammonia feed gas is heated by means of at least one heat exchanger, where heat is absorbed from the product gas stream downstream of the reactor and/or the ammonia feed gas is heated by means of at least one heat exchanger disposed in the flow pathway of a flue gas duct, where heat is absorbed from an offgas stream from a combustion chamber of the reactor or from a tail gas combustion unit.

In a preferred development of the process of the invention, the starting point for provision of the ammonia feed gas is liquid ammonia, which is evaporated with the aid of the thermal energy from hot steam, where this hot steam is obtained by means of at least one heat exchanger interconnected in the plant, through which hot product gas flows downstream of the reactor or the tail gas combustion unit or which is disposed in the flow pathway of a flue gas duct, where heat is absorbed from a flue gas stream from a combustion chamber of the reactor or an offgas stream from the tail gas combustion unit. The use of process steam for the evaporation of the ammonia is advantageous for safety reasons by comparison with the otherwise also possible direct use of flue gas or process gas as heat source, since, for example, damage to a pipe could result in ammonia flowing into the offgas and hence into the atmosphere or getting into the process stream. Electrical evaporation would lead to a high energy consumption and corresponding costs. For safety reasons and economic reasons, therefore, steam is the preferable solution as heat source. Since the ammonia has to be preheated, the evaporation of ammonia preferably consists of at least two heat exchangers in which ammonia is first preheated up to the boiling point and then evaporated.

In a preferred development of the process of the invention, the combustion chamber of the reactor or the tail gas combustion unit is supplied with process air which, prior to introduction into the combustion chamber or the tail gas combustion unit, is preheated in the plant by means of at least one heat exchanger disposed in the flow pathway of a flue gas duct, where heat is absorbed from a flue gas stream from the combustion chamber of the reactor or an offgas stream from the tail gas combustion unit. It is thus possible also to utilize excess process heat obtained in the process for the preheating of the process air.

In a preferred development of the invention, the ammonia cracking reaction is conducted preferably isothermally, quasi-isothermally, or in a mixed form of isothermal and adiabatic process regime.

Preferably, in the process of the invention, the thermal energy present in the flue gas stream from the reactor and/or in the offgas stream from the tail gas combustion unit is utilized in at least three, preferably in at least four, more preferably in at least five, heat exchangers arranged successively in flow direction of the flue gas stream or offgas stream, preferably for different parts of the overall process.

In one possible alternative variant of the process of the invention, the cracking of the ammonia is conducted not in tubes of a reactor but in at least two catalyst beds arranged in series in flow direction, in which case cooling of the process gas as a result of the reaction in a first catalyst bed is followed in each case, downstream of this first catalyst bed, by reheating of the process gas by means of at least one heat exchanger, preferably disposed in a flue gas duct which is fed by the offgas from a tail gas combustion unit.

Preferably, in the aforementioned variant of the process of the invention, the tail gas combustion unit is disposed separately from the catalyst beds and is operated with the tail gas after hydrogen has been separated from the process gas by means of at least one separation device, wherein the separation device preferably comprises a pressure swing adsorption and wherein the tail gas combustion unit is supplied not only with the tail gas but preferably also with combustion air from outside the plant.

In a further possible alternative variant of the process of the invention, at least one electrical heating device is preferably used in an auxiliary manner in order to heat up the process gas, especially in order to bring the process gas to the inlet temperature envisaged therefor before it enters the next catalyst bed when multiple catalyst beds connected in series in flow direction are used. A portion of the heating output can be introduced in accordance with the invention by electrical power. This provides the option, for example, of dispensing with the use of fresh ammonia as fuel and instead using solely the offgas from the hydrogen purification unit as fuel. The supply of electrical energy can especially reduce the number of catalyst beds used. The electrical heating elements may be used directly in the gas space and ensure the increase in temperature to the envisaged inlet temperature into the next catalyst bed. It is possible here, for example, to bring about an increase in temperature by up to 200° C. by means of electrical heating elements; for example, it is possible to electrically heat up a process gas that has been cooled down to about 450° C. to about 650° C. to temperatures of about 650° C. to about 850° C. The elevated temperature is not problematic in terms of materials since the heating can be effected, for example, not in a pipeline but in a duct lined with heat-shielding masonry, which means that the actual pressure shell is protected from the high temperatures.

The present invention further provides a plant for production of hydrogen by cracking of ammonia, comprising a cracking apparatus having a reactor or at least one catalyst bed for catalytic cracking of ammonia to hydrogen and nitrogen with supply of heat, where there is an evaporation apparatus which is disposed upstream of the cracking apparatus and in which liquid ammonia is heated and evaporated, wherein, according to the invention, the evaporation apparatus comprises at least two heat exchangers, where at least one first heat exchanger is designed as a preheater in order to preheat the ammonia and at least one second heat exchanger, disposed downstream of the first heat exchanger in the flow pathway, is designed as an evaporator, and wherein, for the operation of at least one of these heat exchangers, steam is supplied as heat source, which is generated by means of process heat in a steam generation device of the plant. The use of steam from the plant as heat source for preheating and evaporation of the initially liquid ammonia is advantageous economically and for safety purposes, with preferably countercurrent passage of steam and steam condensate generated in the plant through the heat exchangers.

When there is a further steam consumer in the process, for example a reboiler in an ammonia scrubbing unit, it may be advantageous to extend the chain by a third heat exchanger since this steam consumer reduces the amount of steam available and increases the amount of condensate available. In that case, the ammonia may be evaporated, for example, in two parallel heat exchangers. It is also conceivable to preheat the ammonia with warm cooling water, which would add a further heat exchanger to the chain and save process steam and hence combusted ammonia.

In a preferred development of the invention, the plant comprises at least one steam drum that serves as a steam generation apparatus in functional connection to a heat exchanger disposed downstream of a cracking apparatus in a conduit through which hot process gas flows. The process heat present in the hot process gas that leaves the cracking reactor or the catalyst bed is thus preferably taken up and utilized by a heat exchanger to heat steam in a steam drum, where this steam drum is fed with preferably demineralized water which is fed into a conduit system of the plant. The steam thus generated is then fed into the heat exchanger disposed in the region of the front end of the plant, which serves to evaporate the ammonia, which is then fed to the reactor or the catalyst bed in preheated form.

In a preferred development of the invention, the plant further comprises further units for heat recovery and/or facilities for ammonia recovery and/or facilities for hydrogen purification. Heat that enables recovery is available in two streams in a plant of the invention: firstly the process heat from the process of catalytic cracking of ammonia, which comprises a greater mass flow rate but is generally at lower temperature, and secondly the heat present in the flue gas from the combustion, which is generally at much higher temperature but typically has a lower proportion by mass. Efficient thermal integration increases the overall yield of the process.

In a preferred development of the invention, a further unit included for heat recovery in the conduit system downstream of the reactor or a catalyst bed may, for example, be at least one gas-gas heat exchanger through which the following gases flow: on the one hand, hot process gas from the reactor or catalyst bed, and, on the other hand, the ammonia feed gas stream to be heated, which is supplied to the reactor or catalyst bed. In this variant, heat recovered from the process heat is utilized for heating of fresh process gas.

Alternatively or additionally, a further unit included for heat recovery may, for example, be at least one heat exchanger in a flue gas duct downstream of a combustion chamber of the reactor or downstream of a tail gas combustion unit in the plant. Such a measure utilizes heat from the flue gas from the combustion unit.

Finally, the present invention provides the use of a plant having the abovementioned features in a process for producing hydrogen by cracking of ammonia, as described above.

The present invention is elucidated in detail hereinafter by working examples with reference to the appended drawings. The figures show:

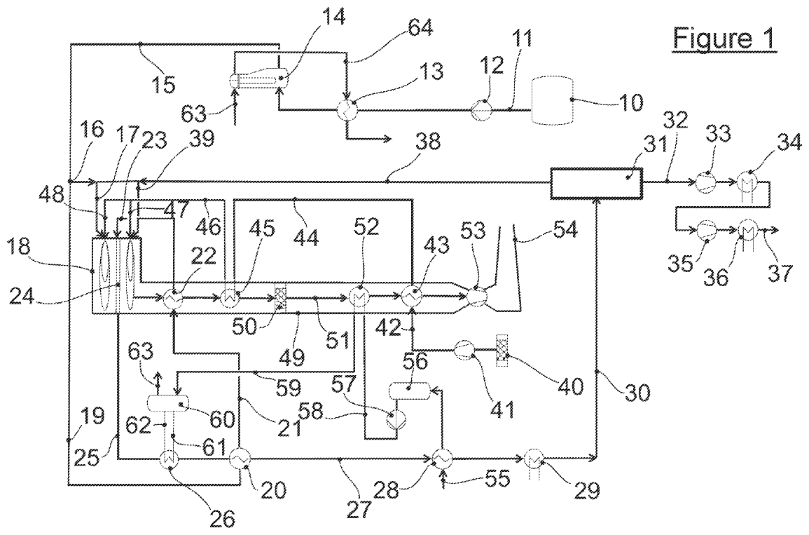

FIG. 1: a representation of a flow diagram of a plant for cracking of ammonia in a first working example of the present invention;

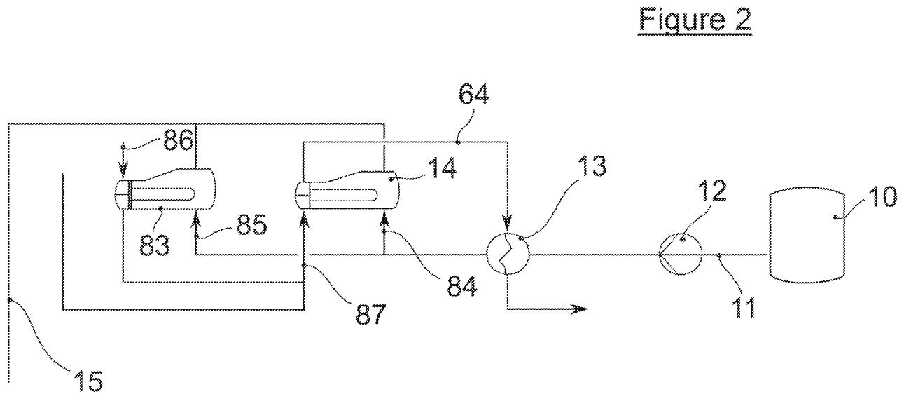

FIG. 2: an enlarged representation of part of an alternative plant of the invention in which ammonia is evaporated;

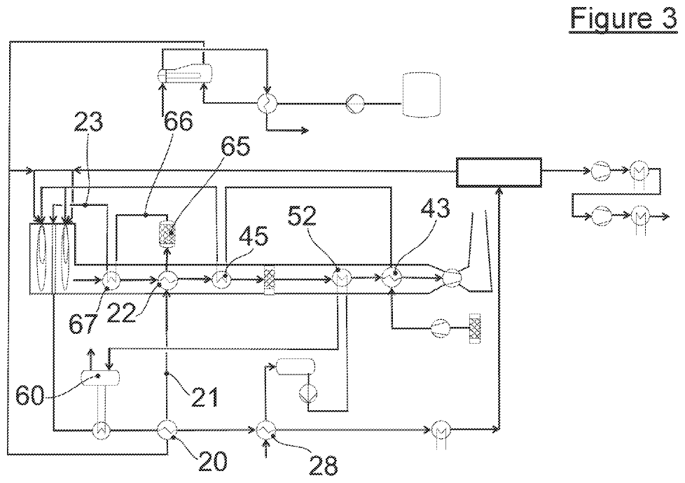

FIG. 3: a representation of a flow diagram of a plant for cracking of ammonia in a second working example of the present invention;

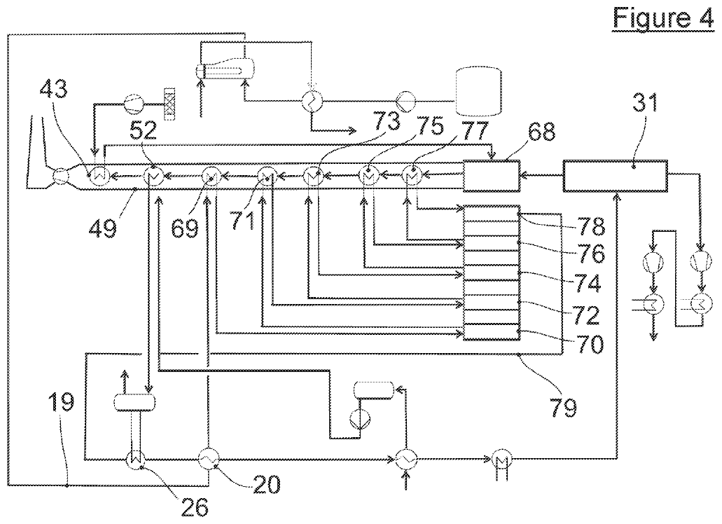

FIG. 4: a representation of a flow diagram of a plant for cracking of ammonia in a third working example of the present invention;

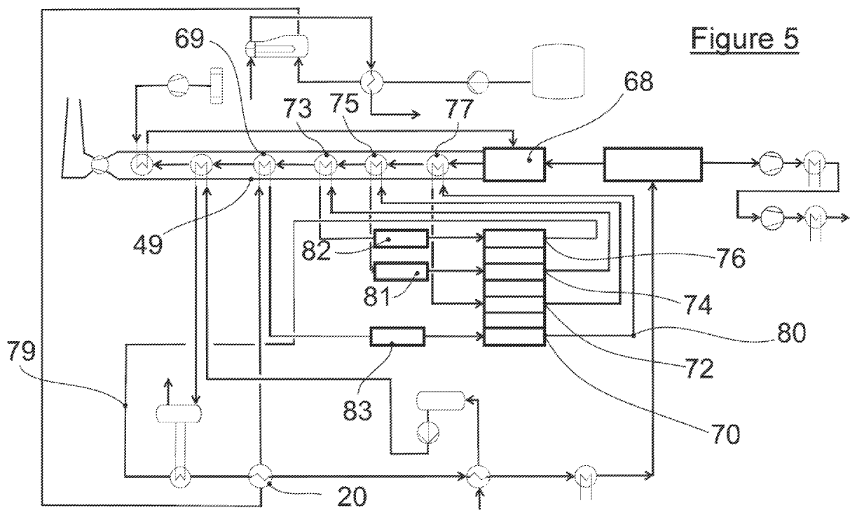

FIG. 5: a representation of a flow diagram of a plant for cracking of ammonia in a fourth working example of the present invention.

There follows an elucidation with reference to FIG. 1 of a first illustrative flow diagram of a plant for cracking of ammonia. Liquid ammonia from an ammonia tank 10, at low temperature and elevated pressure, is directed through the preheater 13 by means of the pump 12 via the conduit 11 and heated, is evaporated in the evaporator 14, and flows through the conduit 15 at a temperature of, for example, about 58° C. to a branch 16, where the ammonia gas stream is divided into two substreams. Proceeding from this branch 16, a first substream of the ammonia gas is fed via the conduit 17 to the combustion chamber of a reactor 18, constructed analogously to a primary reformer. A second substream, proceeding from the branch 16, is directed via the conduit 19 through a first heat exchanger 20 and then flows onward via the conduit 21 through a second heat exchanger 22, where the ammonia gas is heated further and then flows via the conduit 23 into the tubes 24 of the reactor 18 (primary reformer), where the catalyst is present, such that the catalytic reaction of ammonia cracking takes place in these tubes 24. The tubes 24 extend in the combustion chamber, where the flow through the tubes 24 is preferably from the top downward. The ammonia cracking reaction that takes place in the tubes is endothermic, and the heat required for the maintenance of the reaction is generated in that the tubes 24 are heated up in the combustion chamber by combustion of ammonia.

In spite of supply of heat, the temperature of the process gas directed through the tubes 24 and on exit from the reactor 18 effected via the conduit 25 is, for example, about 150° C. lower than on entry of the ammonia gas into the tubes via the conduit 23. The process gas after the ammonia cracking flows through a further heat exchanger 26 in the conduit, then flows through the heat exchanger 20 in crosscurrent, flows through the conduit 27 and, for further cooling, flows through a further heat exchanger and preheater 28, which is operated, for example, with demineralized water at 40° C. for example. Finally, the process gas is cooled down further by means of a process cooler 29 to a temperature of 35° C. for example, and is then fed via a conduit 30 to a pressure swing adsorption 31 (PSA), where the gas mixture is separated under pressure by adsorption. The hydrogen separated off here leaves the PSA 31 via the conduit 32, is brought to an elevated pressure by means of a first compressor 33, flows through a heat exchanger 34, a second compressor 35 to further increase the pressure and a second heat exchanger 36, and is discharged from the plant via the conduit 37 at a pressure of about 70 bar for example.

The tail gas mixture remaining in the pressure swing adsorption 31 after removal of the hydrogen contains nitrogen, water, residual ammonia and residual hydrogen, and is returned via the recycle conduit 38 at comparatively low temperature in the order of magnitude of 40° C. for example and fed via the branching conduit 39 to the combustion chamber of the reactor 18, such that energy present in the tail gas mixture can be utilized for the heating of the combustion chamber.

The combustion air for the combustion process in the reactor 18 is fed in purified form to the plant via a filter 40, compressed by means of the compressor 41, directed via the conduit 42 through the heat exchanger 43 and heated, then flows via the conduit 44 and through a further heat exchanger 45, is heated further therein, and then flows via the conduit 46 and the two branch conduits 47 and 48 that branch off therefrom into the combustion chamber of the reactor 18, where the combustion air is supplied to the substream of the ammonia fed in via the conduit 17 in order to combust it and hence to heat the combustion chamber.

The hot offgas mixture from the combustion in the reactor 18 is first cooled down by means of the heat exchanger 22, which recovers energy for the heating of the process gas fed to the tubes 24 of the reactor 18. The flue gas is then directed further through a flue gas duct 49 via the heat exchanger 45, by means of which the combustion air is preheated, and then flows through the flue gas denoxing unit 50, by means of which the flue gas stream is freed of nitrogen oxides (NOx). The flue gas then flows via the conduit 51 through a further heat exchanger 52, which recovers heat for heating of water, and then flows through the further heat exchanger 43, which likewise serves for heating of the combustion air. The flue gas is then compressed in the end region of the flue gas duct 49 by means of the flue gas compressor 53 and leaves the plant via a chimney 54.

Demineralized water for generation of steam is fed into the plant via the conduit 55 at a temperature of about 40° C. for example, and is passed through the preheater 28 and is then directed at a temperature of about 135° C. for example into a deaerator 56 (degasser) in which air and other gases dissolved in the water are removed. By means of the pump 57, the water is directed through the heat exchanger 52 via the conduit 58 and hence heated to a temperature of about 230° C. for example. The heat exchanger 52 serves to cool down the flue gases from the reactor in the flue gas duct 49 with utilization of the thermal energy present in the flue gas for superheating of the steam, which is then directed via the conduit 59 into a steam drum 60 after passing through the heat exchanger 52. From this steam drum 60, boiler feed water can be directed via the conduit 61 through the heat exchanger 26 and hence can absorb further thermal energy, in order then to be recycled via the conduit 62 to the steam drum. The heat exchanger 26 is disposed downstream of the reactor 18 in the conduit 25 and serves to cool down the process gas after it leaves the reactor. The thermal energy recovered can thus be utilized for generation of further steam.

The steam at about 240° C. for example which is generated in the steam drum 60 is introduced via the conduit 63 into the evaporator 14 shown in the upper region of the drawing. The condensation of the steam recovers the energy to evaporate the preheated ammonia. After flowing through the evaporator 14, the condensate is fed via the conduit 64 to the preheater 13, which serves to preheat the ammonia such that the energy present in the vapor is utilized in two stages for the heating of the ammonia feed. After passing through the heat exchanger 13, the condensate can be discharged from the plant at temperatures of 40° C. for example.

There follows an elucidation in detail with reference to FIG. 3 of a second working example of a plant of the invention for cracking of ammonia to hydrogen and nitrogen. A number of plant components in this variant of the process are identical to the corresponding plant components of the variant of FIG. 1 and will therefore not be elucidated in detail again, but reference will instead be made to the details above. Identical plant components are identified by the in each case same reference numerals. What is unchanged is the front end region in which the originally liquid ammonia is heated and evaporated, as is the region downstream of the pressure swing adsorption after removal of the hydrogen (top right in the drawing). In a departure from the variant of FIG. 1, there are now a total of five rather than four heat exchangers disposed in the flue gas duct 49. The conduit 21 for the heating of the ammonia feed stream here too leads from the gas-gas heat exchanger 20 to the heat exchanger 22 disposed in the offgas duct 49. However, the ammonia gas feed stream, after passing through the heat exchanger 22, is directed through a prereformer 65, with cooling of the feed stream from about 650° C. for example to about 500° C. for example, and then directing of the feed stream via the conduit 66 to a further heat exchanger 67 disposed upstream of the heat exchanger 22 in the offgas duct 49.

The feed gas stream is heated up again therein, for example to a temperature in the order of magnitude of about 650° C., and is then introduced into the tube(s) of the reactor 18 via the conduit 23. The combustion air for the combustion chamber is heated up in the same way as described above in FIG. 1, firstly by heating via the heat exchanger 43 and then by further heating via the heat exchanger 45, where the two heat exchangers 43 and 45 are disposed in the flue gas duct 49. The heating and evaporating of the demineralized water fed to the plant for the steam drum 60 via the preheater 28 and the heat exchanger 52, disposed in the flue gas duct 49, are in principle effected in the same way as in the variant of FIG. 1. In the alternative variant according to FIG. 3—viewed in the sequence in flow direction of the flue gas—the five heat exchangers 67, 22, 45, 52 and 43 are thus in a successive arrangement.

The crucial difference in the reaction regime according to FIG. 3 by comparison with that of FIG. 1 is that the feed gas preheating is limited to lower temperatures of about 650° C. for example, which also increases the lifetime of the reactor steel in contact with the ammonia. For this purpose, the incoming gas stream is first preheated to about 650° C. for example, and then a portion of the reaction is conducted in the prereformer 65. Subsequently, the feed gas stream including the partly already cracked ammonia is heated once again, for example again to a temperature of about 650° C., and directed into the reactor 18 which is of analogous construction to a primary reformer, where the rest of the reaction takes place.

There follows an elucidation in detail with reference to FIG. 4 of a further variant of the process of the invention. In this variant, it is possible to achieve an adiabatic reaction regime, but with external energy supply. Here too, it is possible to avoid the abovementioned material problem (rapid corrosion of the pipe material through nitration), in that the heat is added to the feed gas stream gradually in stages and it is utilized in several catalyst beds to supply the reaction with energy. The beds may either be arranged in the form of a tray reactor in which all the catalyst beds are stacked one on top of another, as shown in FIG. 4, or alternatively two or more reactors may also be designed as separate vessels. A burner system preferably burns the tail gas from the hydrogen workup and optionally additional ammonia, if required. The flue gas from this burner system serves as energy source for the reaction.

In the variant of FIG. 4, the ammonia feed gas that has been preheated in the gas-gas heat exchanger 22 and then heated further in the further heat exchanger 69 to the envisaged reaction temperature of about 650° C. for example is introduced into a first catalyst bed 70 and partly cracked therein, with lowering of the temperature by the reaction to about 400 to 450° C. for example. The process gas that has thus been cooled somewhat is directed through a heat exchanger 71, where it is heated back to the envisaged reaction temperature of about 650 for example, and introduced into the second catalyst bed 72, where at least a proportion of the ammonia present in the feed gas stream is again cracked. The heat exchanger 71 is disposed in a flue gas duct 49, and so the hot flue gas serves to heat up the feed gas stream. The feed gas that has been cooled somewhat after the reaction in the second catalyst bed is directed again through a heat exchanger 73 present in the flue gas duct 49, where it is heated again, and then introduced into the third catalyst bed 74. It then flows in a corresponding manner through a third heat exchanger 75, a fourth catalyst bed 76, a fourth heat exchanger 77 and a fifth catalyst bed 78 and, after leaving the fifth catalyst bed 78, the still-hot process gas flows via the conduit 79 through the heat exchanger 26 that serves to generate steam, then flows through the gas-gas heat exchanger 20 and thence to the pressure swing adsorption 31, in which hydrogen is separated from the product gas stream. In the case of an arrangement of five catalyst beds in series, for example, according to the variant of FIG. 4, it is possible to achieve the same conversion as in an isothermal reaction regime. The preheating of the feed stream is limited to about 650° C. for example, in order to reduce the nitration of the steel used, with a rise in the exit temperatures of the catalyst beds of about 450° C. to about 600° C. for example.

The gases separated off in the pressure swing adsorption 31 after the removal of the hydrogen, namely residual ammonia, nitrogen, water and residual hydrogen, are fed into the tail gas combustion unit 68, where they are combusted together with the combustion air fed in via the conduit, where the flue gas leaving the tail gas combustion unit can have a comparatively high temperature of more than 1000° C., especially of above 1100° C., especially of above 1200° C., especially of above 1300° C., more preferably of more than 1400° C., such that the flue gas contains sufficient thermal energy to have a sufficient temperature even after flowing through the cascade of heat exchangers 77, 75, 73, 71 disposed in the flue gas duct to heat the ammonia feed gas stream fed in via the conduit 19 to a temperature sufficient for the reaction in the first catalyst bed 70 in the fifth heat exchanger 69 of the cascade.

In the variant according to FIG. 4, there is a total of seven heat exchangers disposed in the flue gas duct 49, with heating of the combustion air as well by means of a heat exchanger 43, which, similarly to the case of the variant of FIG. 1, is arranged as the last heat exchanger beyond the above-described cascade of heat exchangers in the downstream end region of the flue gas duct 49. The heat exchanger 52 that follows upstream of the heat exchanger 43 in the flue gas duct serves to heat the steam and corresponds in principle to the heat exchanger 52 in FIG. 1, likewise disposed in the flue gas duct 49. Since the temperature of the flue gas is significantly higher after the tail gas combustion 68 than in the above-described variants of FIGS. 1 and 2, there may be a greater number of heat exchangers disposed in the flue gas duct 49 in the variant of FIG. 4. The temperature differentials after flow through each heat exchanger in the flue gas duct may, for example, each be about 100° C. to about 220° C. or more for example, such that the flue gas temperature before it flows through the last heat exchanger 43 is still in an order of magnitude of more than 300° C. and is thus sufficient to heat the combustion air which is introduced into the tail gas combustion 68 after heating thereof. Unlike in the case of the two variants of FIGS. 1 and 3, it is thus the case in the variant of FIG. 4 that the residual gas combustion 68 is utilized as energy source for stepwise heating of individual catalyst beds 70, 72, 74, 76, 78, and the reaction in these catalyst beds is effectively spatially separated from the tail gas combustion 68. In the variant of FIG. 1, by contrast, the combustion of tail gas is optionally effected in a mixture with fresh ammonia and the combustion air in a reactor 18, with the feed stream of ammonia gas flowing through the tube(s) thereof, such that the ammonia gas feed stream is heated directly by this combustion process in the reactor 18.

There follows an elucidation in detail of a further working example of the invention with reference to FIG. 5. In this variant, a portion of the heating output may be introduced by electrical power. In the extreme case, the fuel used is not fresh ammonia, but solely the offgas from the hydrogen purification. In this case, the maximum possible amount of hydrogen is generated, which is determined solely by the yield of the hydrogen purification. In this variant, however, this benefit is opposed by the requirement to use not inconsiderable amounts of electrical energy. FIG. 5 shows an illustrative process concept of the invention with a four-stage reactor cascade and additional electrical heating.

Similarly to the above-described variant of FIG. 4, in the working example according to FIG. 5, a tail gas combustion unit 68 is provided, with a number of heat exchangers disposed in the flue gas duct 49 thereof. The ammonia cracking reaction proceeds in a total of four series-connected catalyst beds 70, 72, 74, 76, where the ammonia feed gas stream is directed first through the gas-gas heat exchanger 20 and the heat exchanger 69 in the flue gas duct 49 and then heated further by means of an electrical heating device 88 to the intended inlet temperature into the first catalyst bed 70 of about 650° C. for example. The electrical heating device can be used merely in an auxiliary manner, meaning that the preheating prior to the further electrical heating can already achieve, for example, heating to a temperature of more than 600° C. The reaction in the first catalyst bed 70 results in cooling of the process gas, for example to a temperature in the region of about 450° C., and the cooled process gas can then be fed to the heat exchanger 77 for reheating via the conduit 80, and thence introduced into the second catalyst bed 72. This first heat exchanger 77, after flow through the first catalyst bed, unlike in the case of the working example of FIG. 4, is that heat exchanger which is disposed immediately downstream of the tail gas combustion 68. After flow through the second catalyst bed 72, the process gas is heated up again in that it is directed through the heat exchanger 75 in the flue gas duct 49. In addition, a further electrical heating device 81 may be provided in order to heat up the process gas to the intended inlet temperature before introduction into the third catalyst bed 74, which may, for example, be higher than in the case of the first and second catalyst beds 70, 72 and may especially be 700° C. to above 800° C., for example about 850° C.

After passing through the third catalyst bed 74, the process gas can be directed through a further heat exchanger 73 in the flue gas duct 49 and then heated electrically in an auxiliary manner by means of the electrical heating device 82 to a temperature which is envisaged for entry into the fourth catalyst bed 76 and may in turn be higher than in the case of the first and second catalyst beds. For example, the entry temperature into the fourth catalyst bed 76 is more than 700-800° C., for example about 840° C. In this way, it is possible to use a plurality of, for example three, electrical heating device 79, 81, 82 in an auxiliary manner for the heating of the process gas to the inlet temperature envisaged for the respective catalyst bed, although, as in the examples described above, the heat from the offgas of the residual gas combustion through multiple heat exchangers 73, 75, 77 disposed in the flue gas duct 49 can be used for the most part for the heating of the process gas. After passage through the fourth catalyst bed 76, the hot process gas can be directed in turn via the conduit 79 through the heat exchanger 26, by means of which steam is heated.

FIG. 2, to which reference is made hereinafter, shows a detail in the front end region of a plant of the invention, in which the ammonia is heated and evaporated. The diagram according to FIG. 2 shows an alternative embodiment of this part of the plant. Unlike in the evaporation variant outlined above in association with FIG. 1, there are two evaporators 14, 83 provided here rather than just one, and these may be connected in parallel. The ammonia from the ammonia tank 10 is conveyed by means of the pump 12 through the preheater 13 and then introduced via two mutually parallel conduits 84, 85 in each case into the first evaporator 14 and into the second evaporator 83, where the second evaporator 83 may be fed with steam via the conduit 86, while the first evaporator 14 is fed with steam condensate via the conduit 87. After flowing through the first evaporator 14, the condensate passes through the conduit 64 to the preheater 13 and likewise flows through it with release of heat. The evaporated ammonia gas can be fed via the conduit 15 to a plant for cracking of ammonia as described in FIG. 1, 3, 4 or 5.

### LIST OF REFERENCE NUMERALS

10 ammonia tank
11 conduit
12 pump
13 preheater
14 evaporator
15 conduit
16 branch
17 conduit
18 reactor
19 conduit
20 gas-gas heat exchanger
21 conduit
22 heat exchanger
23 conduit
24 tubes of the reactor
25 exit conduit from the reactor
26 further heat exchanger
27 conduit
28 preheater
29 process cooler
30 conduit
31 pressure swing adsorption, separation device
32 conduit
33 compressor
34 heat exchanger
35 compressor
36 heat exchanger
37 output conduit for hydrogen
38 recycle conduit
39 branch-off conduit
40 filter for combustion air
41 compressor
42 conduit
43 heat exchanger
44 conduit
45 heat exchanger
46 conduit
47 branch conduit
48 branch conduit
49 flue gas duct, offgas duct
50 flue gas denoxing unit
51 conduit
52 heat exchanger
53 flue gas compressor
54 chimney
55 conduit for the feeding of water
56 deaerator
57 pump
58 conduit
59 conduit
60 steam drum
61 conduit
62 conduit
63 conduit
64 conduit
65 prereformer
66 conduit
67 further heat exchanger
68 tail gas combustion unit
69 heat exchanger
70 first catalyst bed
71 heat exchanger
72 second catalyst bed
73 heat exchanger
74 third catalyst bed
75 heat exchanger
76 fourth catalyst bed
77 heat exchanger
78 fifth catalyst bed
79 conduit
80 conduit
81 electrical heating device
82 electrical heating device
83 further evaporator
84 conduit
85 conduit
86 conduit
87 conduit
88 electrical heating device

1-17. (canceled)

18. A plant for production of hydrogen by cracking of ammonia, comprising:
a multistage cracking apparatus having multiple catalyst beds for catalytic cracking of an ammonia feed gas stream to hydrogen and nitrogen with supply of heat;
an evaporation apparatus disposed upstream of the cracking apparatus and in which liquid ammonia is heated and evaporated;
heat exchangers with which the ammonia feed gas is heatable;
a hydrogen reprocessing unit, wherein a burner system of a tail gas combustion unit for combustion of a tail gas from the hydrogen reprocessing unit is provided in order to provide a flue gas from this tail gas combustion unit as energy source for the cracking reaction;
a flue gas duct for the flue gas from the tail gas combustion unit; and
multiple heat exchangers disposed in the flue gas duct, where a first of these heat exchangers is provided for heating of the process gas that has exited from a first catalyst bed and has been cooled down by the reaction in the first catalyst bed to a reaction temperature for a second catalyst bed, where a second of these heat exchangers is provided for heating of the process gas that has exited from the second catalyst bed and has been cooled down by the reaction in the second catalyst bed before it enters a third catalyst bed.

19. The plant as claimed in claim 18, wherein a third heat exchanger is provided in the flue gas duct for heating of the process gas that has exited from the third catalyst bed and has been cooled down by the reaction in the third catalyst bed before it enters a fourth catalyst bed.

20. The plant as claimed in claim 19, wherein a fourth heat exchanger is provided in the flue gas duct for heating of the process gas that has exited from the fourth catalyst bed and has been cooled down by the reaction in the fourth catalyst bed to a reaction temperature for a fifth catalyst bed.

21. The plant as claimed in claim 19, wherein a conduit is provided, via which the still-hot process gas after leaving the last catalyst bed flows through a heat exchanger that serves to generate steam, where the process gas then flows through a gas-gas heat exchanger and thence to a pressure swing adsorption in which hydrogen is separated from the product gas stream.

22. The plant as claimed in claim 19, wherein there is a total of seven heat exchangers or a total of six heat exchangers disposed in the flue gas duct, with the combustion air for the burner system of the tail gas combustion unit also being heated by means of one of these heat exchangers, where this heat exchanger is disposed as the last heat exchanger beyond the cascade of heat exchangers in a downstream end region of the flue gas duct, and where there is a heat exchanger that serves for heating of water and adjoins the last heat exchanger in the upstream direction in the flue gas duct.

23. The plant as claimed in claim 18, wherein electrical heating devices are provided for auxiliary preheating of the respective gas stream entering the catalyst beds to reaction temperature.

24. The plant as claimed in claim 23, wherein the only fuel used in the tail gas combustion unit is the offgas from the hydrogen reprocessing unit.

25. The plant as claimed in claim 18, wherein there is at least one gas-gas heat exchanger disposed in the conduit system downstream of the catalyst beds and through which, on the one hand, the hot process gas from the catalyst beds flows and, on the other hand, the ammonia feed gas stream to be heated flows, which is fed to the first catalyst bed.

26. The use of a plant as claimed in claim 18 for production of hydrogen.

27. A process for producing hydrogen by cracking of ammonia in a multistage cracking apparatus having multiple catalyst beds for catalytic cracking of an ammonia feed gas stream to hydrogen and nitrogen with supply of heat, comprising:
heating and evaporating liquid ammonia in an evaporation apparatus upstream of the cracking apparatus;
heating the ammonia feed gas using heat exchangers;
combusting a tail gas from a hydrogen reprocessing unit using a burner system of a tail gas combustion unit to provide a flue gas from this tail gas combustion unit as energy source for the cracking reaction;
passing the flue gas through a flue gas duct; and
heating a process gas that exits a first catalyst bed and that has been cooled down by the reaction in the first catalyst bed to a reaction temperature for a second catalyst bed using a first heat exchanger in the flue gas duct and heating a process gas that exits a second catalyst bed and that has been cooled down by the reaction in the second catalyst bed before it enters a third catalyst bed using a second heat exchanger in the flue gas duct.

28. The process as claimed in claim 27, wherein a third heat exchanger disposed in the flue gas duct heats the process gas that has exited from the third catalyst bed and has been cooled down by the reaction in the third catalyst bed before it enters a fourth catalyst bed.

29. The process as claimed in claim 28, wherein a fourth heat exchanger disposed in the flue gas duct heats the process gas that has exited from the fourth catalyst bed and has been cooled down by the reaction in the fourth catalyst bed to a reaction temperature for a fifth catalyst bed.

30. The process as claimed in claim 28, wherein a conduit is provided, via which the still-hot process gas after leaving the last catalyst bed flows through a heat exchanger that serves to generate steam, where the process gas then flows through a gas-gas heat exchanger and thence to a pressure swing adsorption in which hydrogen is separated from the product gas stream.

31. The process as claimed in claim 28, wherein there is a total of seven heat exchangers or a total of six heat exchangers disposed in the flue gas duct, with the combustion air for the burner system of the tail gas combustion unit also being heated by means of one of these heat exchangers, where this heat exchanger is disposed as the last heat exchanger beyond the cascade of heat exchangers in a downstream end region of the flue gas duct, and where there is a heat exchanger that serves for heating of water and adjoins the last heat exchanger in the upstream direction in the flue gas duct.

32. The process as claimed in claim 27, wherein auxiliary preheating of the respective gas stream entering the catalyst beds to reaction temperature is effected by means of electrical heating devices.

33. The process as claimed in claim 32, wherein the only fuel used in the tail gas combustion unit is the offgas from the hydrogen reprocessing unit.

34. The process as claimed in claim 27, wherein there is at least one gas-gas heat exchanger disposed in the conduit system downstream of the catalyst beds and through which, on the one hand, the hot process gas from the catalyst beds flows and, on the other hand, the ammonia feed gas stream to be heated, which is fed to the first catalyst bed.
